(19) United States
(12) Patent Application Publication
(10) Pub. No.: US 2003/0185133 A1
(43) Pub. Date: Oct. 2, 2003

(54) Wavelength coupling device and optical pickup apparatus equipped therewith

(76) Inventors: Naoki Kaiho, Yokohama (JP); Ichiro Morishita, Yokohama (JP); Noriyoshi Takeya, Yokohama (JP)

Correspondence Address: BIRCH STEWART KOLASCH & BIRCH, PO BOX 747, FALLS CHURCH, VA, 22040-0747, US

(21) Appl. No.: 10/334,073

(22) Filed: Dec. 31, 2002

(30) Foreign Application Priority Data
Mar. 26, 2002 (JP) 2002-86814

(51) Int. Cl. G11B 7/135

(52) U.S. Cl. 369/112.1

(57) ABSTRACT

Disclosed herewith is a wavelength coupling device which transmits three types of light having three different wavelengths, is composed of a hologram device, is characterized in that at least one type of light of the three types of light incident on the optical transmission medium is emitted at an angle different from its incident angle and the others types of light emitted at angles equal to their incident angles, respectively.

### BACKGROUND OF THE INVENTION

1. Field of the Invention

The present invention relates generally to a wavelength coupling device and optical pickup apparatus equipped therewith that is suitable for use in the field of writing information on and reading information from an optical information storage medium having a large capacity above 20 GB, and more particularly to a wavelength coupling device suitable for use in conjunction with various writing and reading apparatuses, optical pickups, optical pickup components and the like that write information on and read information from three types of optical information storage mediums having different storage densities or different thicknesses of optical transmission protection layers (cover layers), such as a compact disc, a digital versatile disc and a next generation large capacity optical disc (high-density digital versatile disc), and an optical pickup apparatus equipped therewith.

2. Description of the Prior Art

Currently, in order to meet requirements for writing and reading large-sized information, there has been proposed an optical disc (optical information storage medium) having a memory capacity more than 20 GB. In particular, the standard of next generation large capacity optical discs (High-Density Digital Versatile Disc (HD-DVD)), which are capable of storing information of about 27 GB, is being established.

A blue violet (blue or violet) Laser Diode (LD) having a wavelength of 405 nm, an object lens having a Numerical Aperture (NA) of 0.85 and an optical transmission protection layer having a thickness of 0.1 mm have been employed, so an optical disc having a large capacity can be implemented, thus resulting in the HD-DVD.

For a writing and reading apparatus for such HD-DVDs, there is an beam expander type optical pickup apparatus to which a knife edge method is applied, as shown in FIG. 15. In this drawing, reference numeral 1 designates a semiconductor LD for emitting blue light having a wavelength of 405 nm, reference numeral 2 designates collimate lenses, reference numeral 3 designates a beam shaping prism where a set of prisms are arranged in opposite directions, reference numeral 4 designates half-wavelength plates, reference numeral 5 designates a diffraction grating, reference numeral 6 designates polarizing beam splitters, reference numeral 7 designates a quarter-wavelength plate, reference numeral 8 designates a beam expander composed of two lenses, reference numeral 9 designates an object lens that is composed of two sets of optical elements, reference numeral 10 designates a knife edge, reference numeral 11 designates a photodiode for monitoring, reference numeral 12 designates a photodiode for servo, reference numeral 13 designates a photodiode for Radio Frequency (RF) and servo, and reference numeral 14 designates a HD-DVD.

In the optical pickup apparatus, the thickness of the HD-DVD 14 is controlled by varying the distance between two lenses that constitute the beam expander 8.

However, even though such an HD-DVD and a writing and reading apparatus therefor are commercialized, there is needed a technology for writing information on and reading information from a Compact Disc (CD) and/or a Digital Versatile Disc (DVD) using the reading and writing apparatus for the HD-DVD because demands for writing information on and reading information from the conventional CD and/or the conventional DVD still remain.

Here, so as to achieve compatibility among the conventional CD, the conventional DVD and the HD-DVD, it is required to equalize the size of the HD-DVD with that of the conventional CD and the conventional DVD. In this case, their track pitch is reduced to a half of 0.32 um, thereby being capable of writing information of 27 GB thereon.

The optical conditions of the CD, the DVD and the HD-DVD are listed in the following table. Additionally, the NA of object lens is a non-dimensional number obtained by an equation of “effective diameter/2/focal length”.

| | Information | Thickness of | |
|---|---|---|---|
| | memory | cover layer | NA of object |
| Optical disc | capacity (GB) | (mm) | lens |
| CD | 0.65 | 1.2 | 0.45 |
| DVD | 4.7 | 0.6 | 0.60 |
| HD-DVD | Over 20 | 0.1 | 0.85 |

As shown in the above table, it is impossible to write information on and read information from the CD, the DVD and the HD-DVD using the same writing and reading apparatus because the HD-DVD is different from the CD and the DVD in the wavelength of laser light or thickness of a cover layer.

Here, an optical system for three thicknesses of cover layers (0.1 mm, 0.6 mm and 1.2 mm) will be described using three types of laser light having wavelengths of 405 nm, 650 nm and 780 nm, respectively, and an object lens having an NA of 0.85.

FIG. 16 is a schematic diagram illustrating an optical system for three types of optical discs having different thicknesses of cover layers. As shown in FIG. 16, reference numeral 21 designates an object lens having an NA of 0.85, reference numeral 22 designates a DVD, reference numeral 23 designates a CD, reference character λ1 designates laser light having a wavelength of 405 nm, reference character λ2 designates laser light having a wavelength of 650 nm, and reference character λ3 designates laser light having a wavelength of 780 nm. In order to read an optical signal from the HD-DVD 14, the object lens 21 having an NA of 0.85 is employed.

In that case, if the distance L between the object lens 21 and the surface of the HD-DVD 14 is designed to be, for example, 0.6 mm, the working distance WD of the object lens, through which the object lens 21 is moved in a range where optical characteristics are valid, is 0.6 mm for the HD-DVD 14 the thickness of whose cover layer is 0.1 mm, 0.6 mm for the DVD 22 the thickness of whose cover layer is 0.6 mm, and 0.3 mm for the CD 23 the thickness of whose cover layer is 1.2 mm.

For example, as shown in FIG. 17a, when the WD1 of the CD 23 is 0.3 mm, the distance L1 between a semiconductor laser 24 for emitting laser light having a wavelength of 780 nm and the object lens 21 is 20 mm.

Since the maximum surface deviation of the CD 23 is 0.6 mm in view of the specification of a CD, the WD1 is insufficient. Additionally, since a plurality of optical elements, such as a collimate lens, a mirror and the like, are arranged to constitute an actual optical pickup apparatus, the distance L1 is insufficient to arrange such elements.

Between the distance F1 (=L1) between the semiconductor laser 24 and the object lens 21 and the distance F2 (=WD+the thickness of a cover layer) between the object lens 21 and the signal surface of the CD 23, the following relation can be established.

F1:F2=C (Constant)

Thus, when the WD1 is lengthened to a WD2 (WD2>WD1), the distance L2 between semiconductor laser 24 and the object lens 21 is shortened (L2<L1) as shown in FIG. 17b. On the contrary, when the distance between the semiconductor laser 24 and the object lens 21 is lengthened to a L3 (L1<L3), the WD1 is shortened to a WD3 (WD1>WD3) as shown in FIG. 17c.

As described above, it is impossible to guarantee a WD1 of 0.3 mm and a L1 of 20 mm only by controlling the relationship among the relative positions of the semiconductor 24, the object lens 21 and the CD 23. Therefore, it is difficult to write information on and read information from the CD 23 the NA of whose object lens 21 is 0.85.

Here, there is proposed a writing and reading apparatus for optical discs that combines an optical pickup for writing information on and reading information from HD-DVDs with another optical pickup for writing information on and reading information from CDs and DVDs.

FIG. 18 is a top view illustrating an essential part of a conventional writing and reading apparatus for three types of optical discs having different thicknesses of cover layers, respectively. As shown in this drawing, the writing and reading apparatus is constructed by arranging an optical pickup 32 provided with an object lens 31 having an NA of 0.85 for writing information on and reading information from a HD-DVD and another optical pickup 35 for writing information on and reading information from a CD or DVD while changing an object lens 33 having an NA of 0.6 for writing information on and reading information from the DVD and an object lens 34 having an NA of 0.45 for writing information on and reading information from the CD, in opposite positions on a disc 37 around the axis 36 of a disc motor.

In the conventional writing and reading apparatus for optical discs, information is written on and read from a DVD or CD with a corresponding one of the object lenses 33 and 34 rotated in position by a changing mechanism (not shown), whereas information is written on and read from a HD-DVD by using the object lens 31.

Then, in the conventional writing and reading apparatus for optical discs, there are required one optical pickup 32 for writing information on and reading information from HD-DVDs, another optical pickup 35 for writing information on and reading information from CDs and DVDs, a drive mechanism including a disc motor for changing the object lenses 31, 33 and 34, and a control mechanism and a control circuit for controlling the above components, so the structure of the apparatus and control thereof are complicated. As a result, there occurs a problem that cost of the apparatus is high. Additionally, the optical pickup 32 for writing information on and reading information from HD-DVDs and the optical pickup 35 for writing information on and reading information from CDs and DVDs are arranged at opposite positions in the radial direction of a disc 37 around the axis 36 of the disc motor, there occur problems in which the sizes of the drive mechanism and the control mechanism are increased and the size of apparatus itself is also increased.

Here, there can be considered a writing and reading apparatus for optical discs that specially combines a drive mechanism and a control mechanism for only HD-DVDs having an optical pickup for writing information on and reading information from the HD-DVD with another drive mechanism and another control mechanism for CDs and DVDs having an optical pickup for writing information on and reading information from the CDs and the DVDs, for the purpose of preventing the sizes of drive mechanisms and control mechanism from being increased. However, in the conventional writing and reading apparatus for optical discs, there is still not solved a problem that the manufacturing cost of the apparatus is high, though the sizes of the drive mechanism and the control mechanism only for HD-DVDs can be reduced.

### SUMMARY OF THE INVENTION

In order to solve this problem, an object of the present invention is to provide a wavelength coupling device and optical pickup apparatus equipped therewith, which does not require a drive mechanism and a control mechanism, can be fabricated to have a small size and manufactured at low cost, and can write information on and read information from three types of optical information storage mediums corresponding to three types of different wavelengths by using a single object lens.

In order to accomplish the above object, the present invention provides a wavelength coupling device and optical pickup apparatus equipped therewith described below.

That is, a wavelength coupling device described in claim 1 is an optical transmission medium for transmitting three types of light having three different wavelengths, characterized in that at least one type of light of the three types of light incident on the optical transmission medium is emitted at an angle different from its incident angle and the others types of light emitted at angles equal to their incident angles, respectively.

In the wavelength coupling device, the focal distance of at least one type of transmitted light can be changed by emitting at least one type of light of the three types of light incident on the optical transmission medium at an angle different from its incident angle and emitting the other types of light at angles equal to their incident angles, respectively. Additionally, the wavelength coupling device does not require a drive mechanism and a control mechanism and has a simple construction, so an apparatus combined with the device can be manufactured at low cost.

The wavelength coupling device described in claim 2 is characterized in that, in the wavelength coupling device of claim 1, the one type of light is emitted at an angle that allows the one type of light to expand from the optical transmission medium along the traveling direction of the one type of light.

The wavelength coupling device described in claim 3 is characterized in that, in the wavelength coupling device of claim 1, the optical transmission medium is a hologram device.

The wavelength coupling device described in claim 4 is characterized in that, in the wavelength coupling device of claim 2, the optical transmission medium is a hologram device.

An optical pickup apparatus disclosed in claim 5, is characterized in that an optical pickup apparatus having three light emitting elements for emitting three types of light having different wavelengths, a lens system provided with an object lens for both focusing light emitted from the light emitting elements on an optical information storage medium, and focusing and transmitting refracted feedback light emitted from the optical information storage medium, and a light receiving element for detecting the transmitted, reflected feedback light, includes a wavelength coupling device according to claim 1, 2, 3 or 4 between a light emitting device and the object lens.

In the wavelength coupling device, the wavelength coupling device is arranged between the light emitting device and the object lens, so it is possible to guarantee a sufficient length WD to drive an object lens in a range where optical characteristics, such as the distance L between the object lens and the surface of optical information storage medium and aberration, are valid for three types of light having three different wavelengths. As a result, information can be written on and read from three types of optical information storage mediums corresponding to the three types of light having three different wavelengths by using a single object lens.

In addition, a drive mechanism and a control mechanism are not required by the optical pickup apparatus of the present invention, so the optical pickup apparatus the can be manufactured at low cost.

The optical pickup apparatus described in claim 6 is characterized in that, in the optical pickup apparatus of claim 5, the reflected feedback light has a polarization direction corresponding to a polarization direction of the emitted light.

The optical pickup apparatus described in claim 7 is characterized in that, in the optical pickup apparatus according to claim 5, a wavelength plate is disposed between the wavelength coupling device and the object lens.

The optical pickup apparatus described in claim 8 is characterized in that, in the optical pickup apparatus according to claim 6, a wavelength plate is disposed between the wavelength coupling device and the object lens.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating an essential part of an optical pickup apparatus according to a first embodiment of the present invention;

FIG. 2 is a side view illustrating a wavelength coupling device of the first embodiment;

FIG. 3 is a diagram illustrating an optical system in which a collimate lens and a concave lens are arranged on the optical axis between a semiconductor laser and an object lens;

FIG. 4 is a schematic diagram illustrating the polarized states of incident light on reflected feedback light of the optical pickup apparatus of the first embodiment;

FIG. 5 is a schematic diagram illustrating the polarized states of incident light and reflected feedback light of the optical pickup apparatus of the first embodiment;

FIG. 6 is a schematic diagram illustrating the polarized states of incident light and reflected feedback light of the optical pickup apparatus of the first embodiment;

FIG. 7 is a schematic diagram illustrating the polarized states of incident light and reflected feedback light of the optical pickup apparatus of the first embodiment;

FIG. 8 is a diagram illustrating an essential part of the optical pickup apparatus of the first embodiment;

FIG. 9 is a schematic diagram illustrating the polarized states of incident light and reflected feedback light of an optical pickup apparatus according a second embodiment of the present invention;

FIG. 10 is a schematic diagram illustrating the polarized states of incident light and reflected feedback light of the optical pickup apparatus of the second embodiment;

FIG. 11 is a schematic diagram illustrating the polarized states of incident light and reflected feedback light of the optical pickup apparatus of the second embodiment;

FIG. 12 is a schematic diagram illustrating the polarized states of incident light and reflected feedback light of the optical pickup apparatus of the second embodiment;

FIG. 13 is a schematic diagram illustrating the polarized states of incident light and reflected feedback light of the optical pickup apparatus of the second embodiment;

FIG. 14 is a schematic diagram illustrating the polarized states of incident light and reflected feedback light of the optical pickup apparatus of the second embodiment;

FIG. 15 is a diagram of a conventional beam expander type optical pickup apparatus;

FIG. 16 is a diagram illustrating an optical system for three types of optical discs having different thicknesses of cover layers, respectively;

FIG. 17 is a schematic diagram illustrating relationship between the distance L between a semiconductor laser and a object lens and an WD in writing information on and reading information from a conventional CD; and

FIG. 18 is a diagram illustrating an essential part of a conventional optical pickup apparatus.

### DESCRIPTION OF THE PREFERRED EMBODIMENTS

With reference to the accompanying drawings, a wavelength coupling device and optical pickup apparatus equipped therewith in accordance with embodiments of the present invention are described below.

These embodiments are examples of the present invention. The present invention is not limited to these embodiments, but the random modification of the present invention is possible within the scope of the inventive concept of the present invention.

### First Embodiment

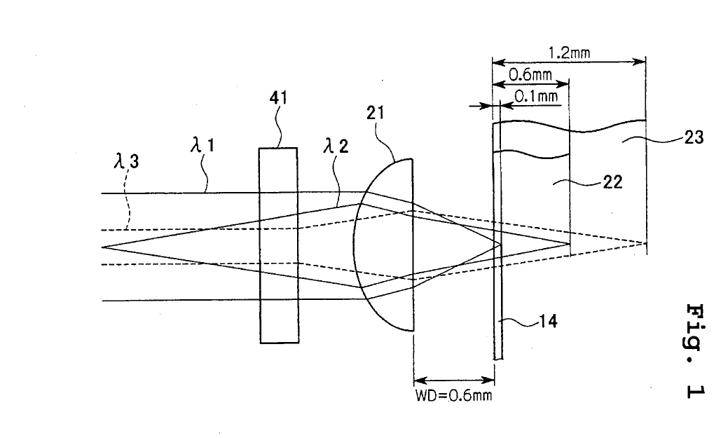

FIG. 1 is a diagram illustrating an essential part of an optical pickup apparatus according to a first embodiment of the present invention. The optical pickup apparatus employs three types of laser light having different wavelengths and an object lens having an NA of 0.85, and is an example of an optical pickup apparatus corresponding to optical discs (optical information storage medium) having different thicknesses of cover layers of, for example, 0.1 mm, 0.6 mm and 1.2 mm, respectively.

As shown in FIG. 1, reference numeral 41 designates a wavelength coupling device that is disposed between the semiconductor laser (light emitting device) and an object lens 21 constituting a part of a lens system. This wavelength coupling device 41 acts on only a type of laser light λ3 of three types of laser light λ1, λ2 and λ3 having three different wavelengths λ1, λ2 and λ3 of 405 nm, 650 nm and 780 nm, respectively, so that the beam of laser light λ3 is emitted at an angle larger than its incident angle and the other types of light λ1 and λ2 are emitted at angles equal to their incident angles, respectively.

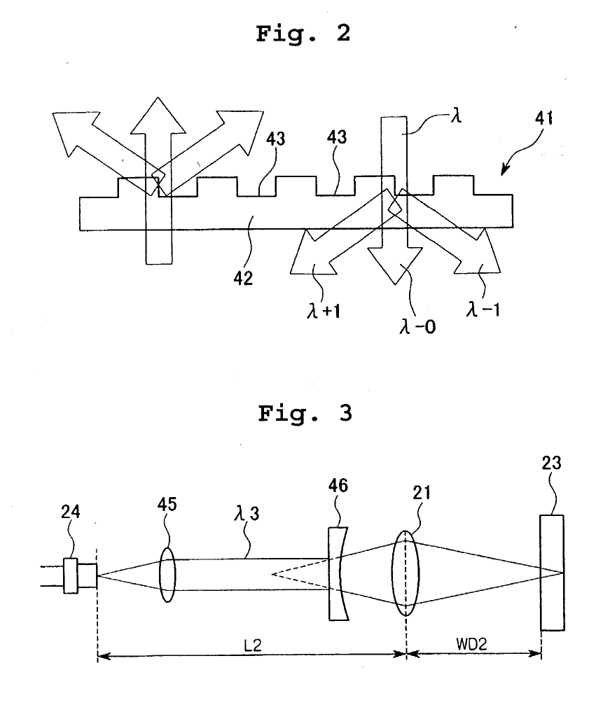

As shown in FIG. 2, in the wavelength coupling device 41, an optical transmission medium constituting an essential part of the wavelength coupling device 41 is composed of a hologram device and transmits three types of laser light having three different wavelengths (405 nm, 650 nm and 708 nm). In the wavelength coupling device 41, a plurality of grooves 43 are closely formed on the upper surface of a flat glass plate 42, thus being able to diffract incident light using these grooves 43.

When laser light λ enters the wavelength coupling device 41, the laser light λ is split into plural beams of diffracted light having different aberration numbers, such as 0 aberration light λ−0, +1 aberration light λ+1 and −1 aberration light λ−1, by the diffracting action of the pattern of the grooves 43.

Although the ratios of split 0 aberration light, +1 aberration light and −1 aberration light and the angles of these diffracted types of light depend on cutting methods, the 0 aberration light (λ−0) travels straight, and the +1 aberration light (λ+1) and the −1 aberration light (λ−1) expands as compared with the 0 aberration light (λ−0). As a result, emitted light can be distorted with respect to the incident light by using lights except for the 0 aberration light (λ−0), that is, the +1 aberration light (λ+1) or −1 aberration light (λ−1).

Here, when the laser light λ3 having a wavelength of 708 nm, for example, 0 aberration light, directly enters an object lens 21, a WD having only, for example, 0.3 mm, is guaranteed for an optical disc the thickness of whose cover layer is 1.2 mm, as described in connection with the prior art. When only the laser light λ3 having a wavelength of 708 nm is used, it is possible to correct the incident angle of the laser light λ3 on the object lens 21, lengthen the focal length and lengthen the WD by arranging a collimate lens 45 and a concave lens 46 on the optical axis between a semiconductor laser 24 and the object lens 21, as shown in FIG. 3.

However, when three types of laser light λ1, λ2, and λ3 are used, the incident angles of the three types of laser light λ1 and λ2 on the object lens 21 are changed by the concave lens 46 and then the WD is also changed. Here, there is required an optical system in which the incident angle of only the laser light λ3 on the object lens 21 is corrected to lengthen the WD and the incident angles of the other types of light λ1 and λ2 are not changed to keep the WD constant.

In this embodiment, the wavelength coupling device 41 is arranged between the semiconductor laser and the object lens 21 constituting a part of the lens system and ±aberration light diffracted by the wavelength coupling device 41 enters the object lens 21, thereby being capable of lengthening the WD to 0.6 mm.

For example, when the laser light λ3 having a wavelength of 780 nm is first applied on an optical disc and the optical disc is distinguished from a CD by a signal outputted from a light receiving element, arranging the concave lens 46 between the object lens 21 and the semiconductor laser may be attempted. However, this is also disadvantageous in that a drive mechanism or drive circuit for driving the concave lens 46 is required.

Next, the polarized states of the incident light and reflected feedback light of three types of laser light λ1, λ2, and λ3 will be described with reference to FIGS. 3 to 7.

(1) Laser Light λ1 (405 nm)

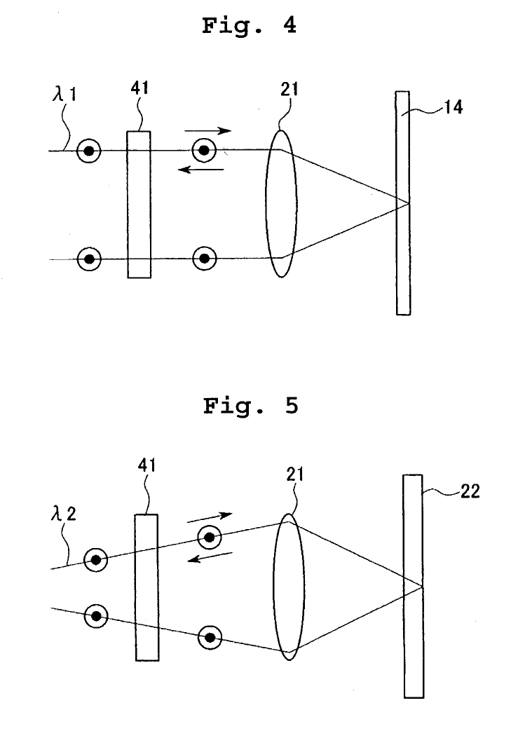

As shown in FIG. 4, parallel laser light λ1 enters the wavelength coupling device 41 in a linearly polarized state. The laser light λ1 is diffracted by the wavelength coupling device 41 and only 0 aberration light in a linearly polarized state is transmitted through the object lens 21 and imaged on the storage surface of the HD-DVD 14, the thickness of whose cover layer is 0.1 mm. Additionally, black dots in circles shown in Figures designate linearly polarized states on a plane vertical to the optical axis.

The reflected feedback light emitted from the storage surface of the HD-DVD 14 is transmitted through the object lens 21 and enters the wavelength coupling device 41 in a linearly polarized state, and then is diffracted by the wavelength coupling device 41. As a result, only 0 aberration light in a linearly polarized state enters a light receiving element (not shown) and is detected.

(2) Laser Light λ2 (650 nm)

As shown in FIG. 5, parallel laser light λ2 enters the wavelength coupling device 41 in a linearly polarized state. This laser light λ2 is diffracted by the wavelength coupling device 41 and only 0 aberration light in a linearly polarized state is transmitted through the object lens 21 and imaged on the storage surface of the DVD 22, the thickness of whose cover layer is 0.6 mm. Additionally, black dots in circles shown in the drawing designate linearly polarized states on a plane vertical to the optical axis.

The reflected feedback light emitted from the storage surface of the DVD 14 is transmitted through the object lens 21, enters the wavelength coupling device 41 in a linearly polarized state, and then is diffracted by the wavelength coupling device 41. As a result, only 0 aberration light in a linearly polarized state enters a light receiving element (not shown) and is detected.

(3) Laser Light λ3 (780 nm)

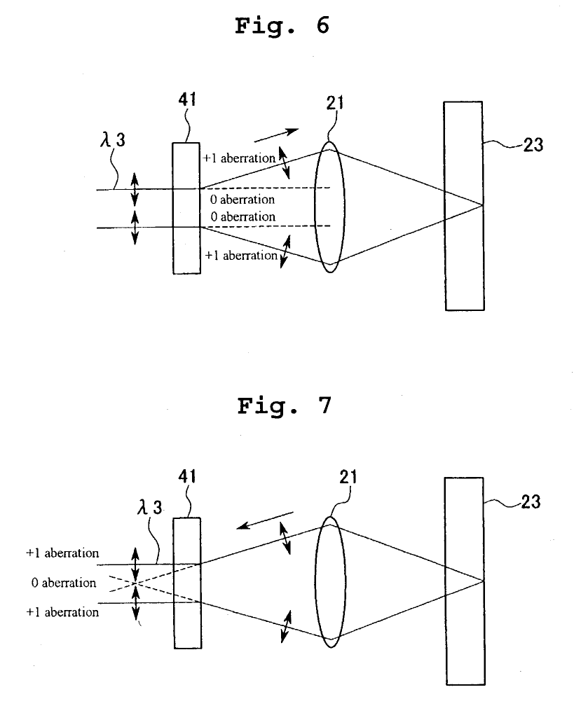

As shown in FIG. 6, laser light λ3 made parallel by the collimate lens is rotated at an angle of 90 degrees and enters the wavelength coupling device 41 in a linearly polarized state. The laser light λ3 is diffracted by the wavelength coupling device 41 and +1 aberration light of emitted light in a 90-degree rotated linearly polarized state is transmitted through the object lens 21 and imaged on the storage surface of the CD 23, the thickness of whose cover layer is 1.2 mm. Additionally, black dots in circles shown in the drawing designate 90-degree rotated linearly polarized states on a plane vertical to the optical axis.

As shown in FIG. 7, the reflected feedback light emitted from the storage surface of the CD 23 is transmitted through the object lens 21, enters the wavelength coupling device 41 in a 90-degree rotated linearly polarized state, and then is diffracted by the wavelength coupling device 41. As a result, +1 aberration light of parallel light in a 90-degree rotated linearly polarized state enters a light receiving element (not shown) and is detected.

As described above, in the optical pickup apparatus according to the present embodiment, the wavelength coupling device 41 comprised of a hologram device is arranged between the semiconductor laser and the object lens 21 constituting a part of a lens system, so it is possible to lengthen the WD by correcting the incident angle of only the laser light λ3 of three types of laser light λ1, λ2, and λ3 on the object lens 21 and to keep the WD constant by not changing the incident angles of the other types of light λ1 and λ2 on the object lens 21. As a result, for the three types of laser light λ1, λ2, and λ3, the distance L between the object lens 21 and the surface of the optical disc, and the WD are sufficiently guaranteed, thereby being capable of writing information on and reading information from three types of optical discs the thickness of whose cover layers are different from each other by using one object lens.

In addition, a hologram device can be preferably employed as the wavelength coupling device 41, so the optical pickup apparatus can be implemented in a simple structure and manufactured at low price.

### Second Embodiment

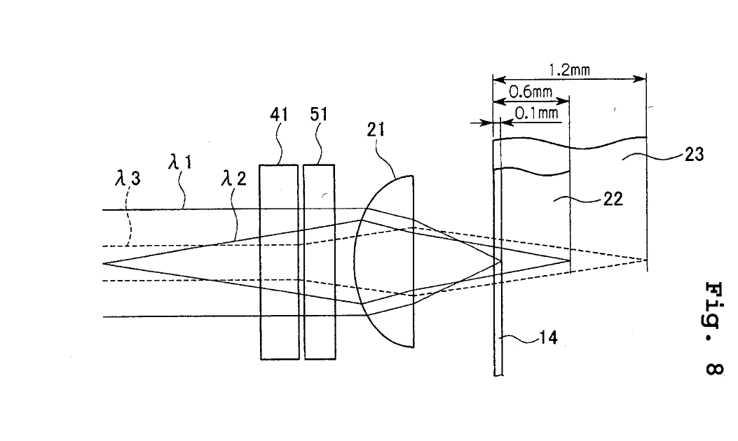

FIG. 8 is a diagram illustrating an essential part of optical pickup apparatus according to a second embodiment of the present invention. The optical pickup apparatus of the second embodiment is different from that of the first embodiment in that a λ/4 wavelength plate 51 is arranged on the optical axis between the object lens 21 and the wavelength coupling device 41.

The λ/4 wavelength plate 51 functions as a λ/4 wavelength plate for laser light λ1 having a wavelength of 405 nm, and functions as a λ/2 wavelength plate for laser light λ2 having a wavelength of 650 nm and laser light λ3 having a wavelength of 780 nm.

Additionally, the polarized states of the incident light and reflected feedback light of three types of laser light λ1, λ2, and λ3 will be described with reference to FIGS. 9 to 14.

(1) Laser Light λ1 (405 nm)

As shown in FIG. 8, parallel laser light λ1 enters the wavelength coupling device 41 in a linearly polarized state. This laser light λ1 is diffracted by the wavelength coupling device 41 and only 0 aberration light in a linearly polarized state enters the λ/4 wavelength plate 51. The 0 aberration light is changed from a linearly polarized state to a circularly polarized state by the λ/4 wavelength plate 51, transmitted through the object lens 21, and imaged on the storage surface of a HD-DVD 14, the thickness of whose cover layer is 0.1 mm. Additionally, black dots in circles shown in FIG. 9 designate linearly polarized states on a plane vertical to the optical axis, while rings shown in FIG. 9 designate circularly polarized states on a plane vertical to the optical axis.

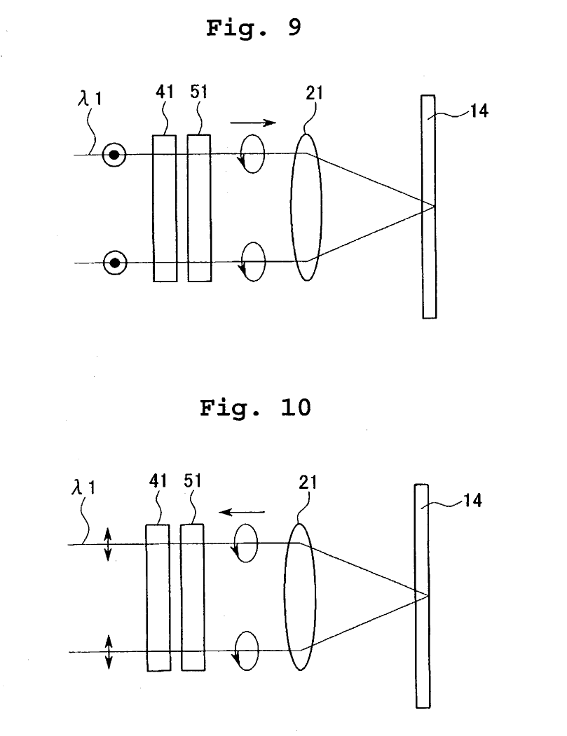

As shown in FIG. 10, reflected feedback light emitted from the storage surface of this HD-DVD 14 is transmitted through the object lens 21 and enters the λ/4 wavelength plate 51 in a circularly polarized state. The reflected feedback light incident on the λ/4 wavelength plate 51 is changed from a circularly polarized state to a 90-degree rotated linearly polarized state by the λ/4 wavelength plate 51, enters the wavelength coupling device 41 in the 90-degree rotated linearly polarized state, and then is diffracted by the wavelength coupling device 41. As a result, only 0 aberration light in a linearly polarized state enters a light receiving element (not shown) and is detected.

(2) Laser Light λ2 (650 nm)

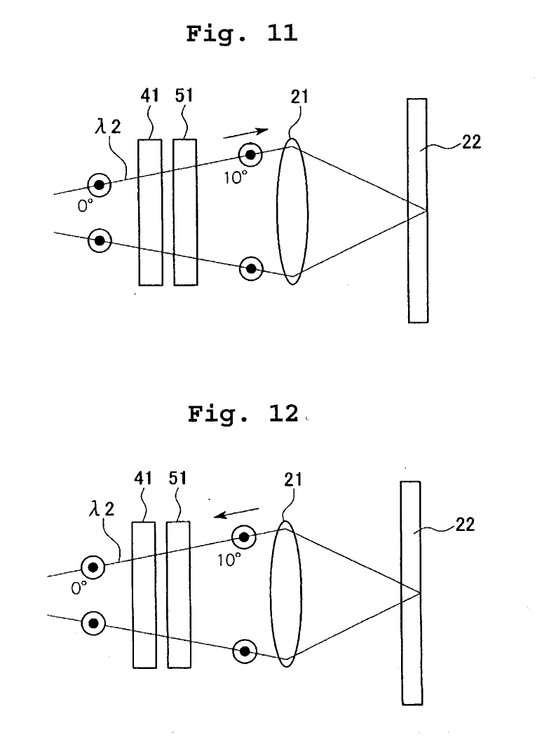

As shown in FIG. 11, parallel laser light λ2 enters the wavelength coupling device 41 in a linearly polarized state. This laser light λ2 is diffracted by the wavelength coupling device 41 and only 0 aberration light in a linearly polarized state enters the λ/4 wavelength plate 51. Since the λ/4 wavelength plate 51 functions as a λ/2 wavelength plate for laser light λ2 having a wavelength of 650 nm, the laser light λ2 is rotated at an angle of, for example, 10 degrees, transmitted through the object lens 21 in a 10-degree rotated linearly polarized state and imaged on the storage surface of the DVD 22, the thickness of whose cover layer is 0.6 mm.

As shown in FIG. 12, the reflected feedback light emitted from the storage surface of the DVD 22 is transmitted through the object lens 21 and enters the λ/4 wavelength plate 51. Since the λ/4 wavelength plate 51 functions as a λ/2 wavelength plate for the laser light λ2 having a wavelength of 650 nm, the light incident on the λ/4 wavelength plate 51 enters the wavelength coupling device 41 in a linearly polarized state with the rotated portion of the incident light returned to its initial state. The light incident on the wavelength coupling device 41 is diffracted by the wavelength coupling device 41. Finally, 0 aberration light in a linearly polarized state enters a light receiving element (not shown) and is detected.

(3) Laser Light λ3 (780 nm)

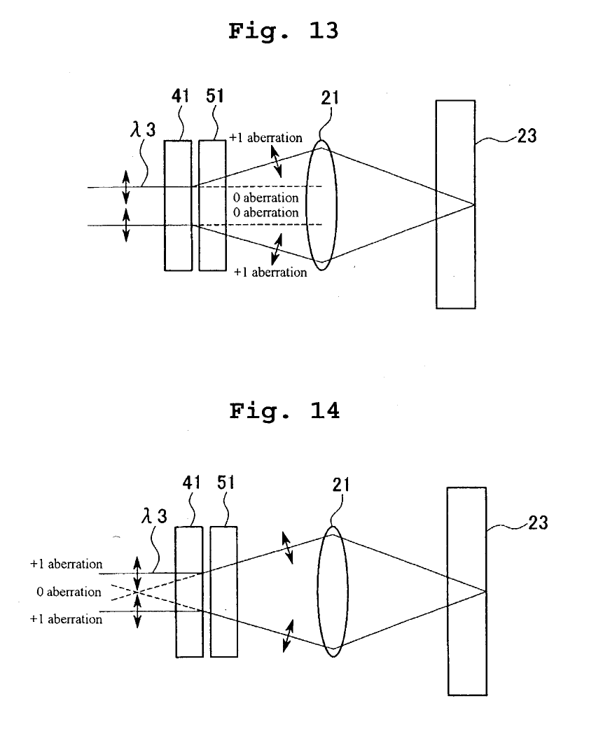

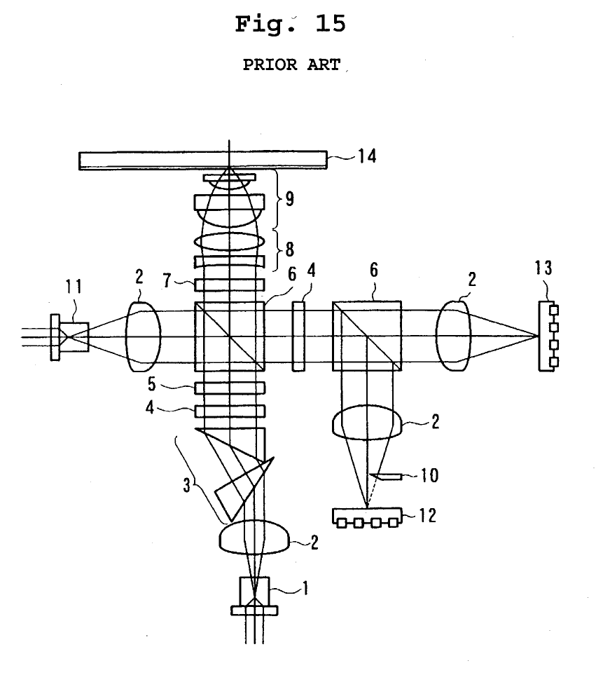

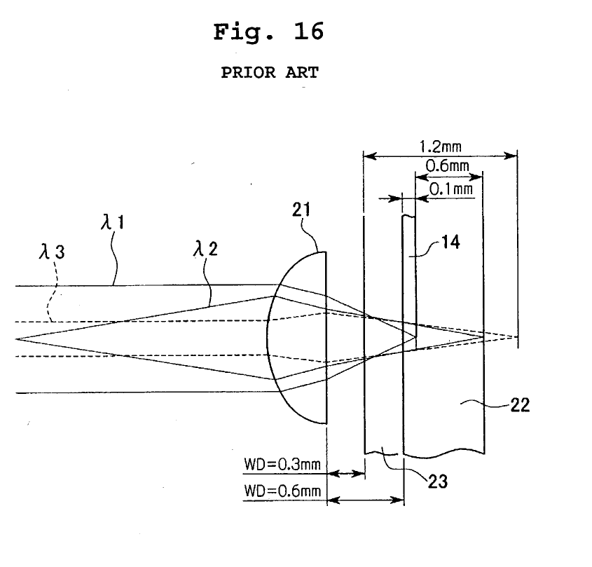

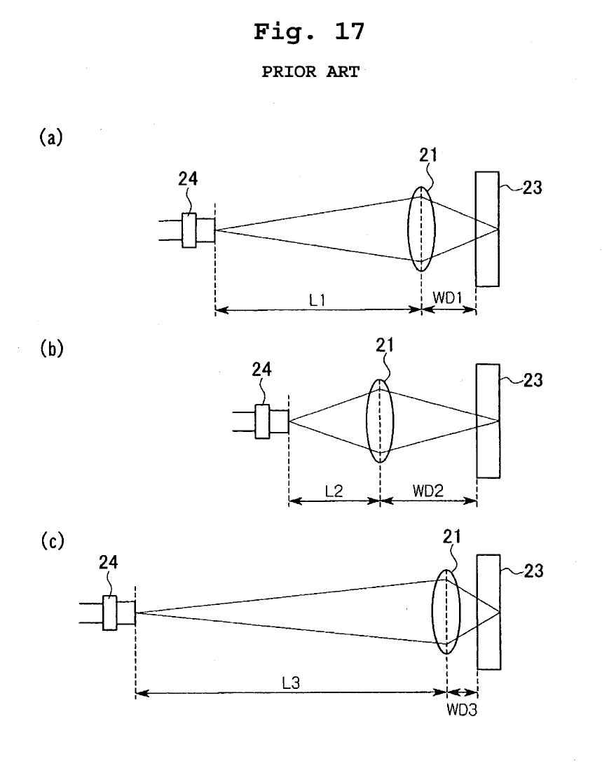

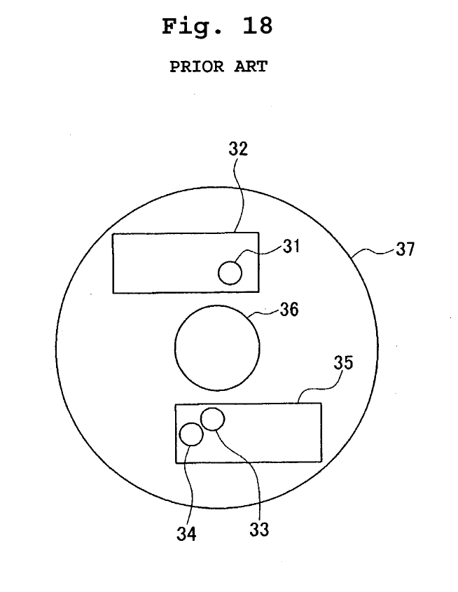

As shown in FIG. 13, the laser light λ3 made parallel by the collimate lens is rotated at an angle of 90° and enters the wavelength coupling device 41 in a linearly polarized state. This laser light λ3 is diffracted by the wavelength coupling device 41 and the +1 aberration light of emitted light in a 90-degree rotated linearly polarized state enters the λ/4 wavelength plate 51. Since the λ/4 wavelength plate 51 functions as a λ/2 wavelength plate for laser light λ3 having a wavelength of 780 nm, the laser light λ3, for example, in a 90-degree rotated linearly polarized state, is rotated at an angle of 10 degrees, transmitted through the object lens 21 in a 80-degree rotated linearly polarized state and imaged on the storage surface of the CD 23, the thickness of whose cover layer thickness is 1.2 mm.

As shown in FIG. 14, reflected feedback light emitted from the storage surface of the CD 23 is transmitted through the object lens 21 and enters the λ/4 wavelength plate 51 in an 80-degree rotated linearly polarized state. Since the λ/4 wavelength plate 51 functions as a λ/2 wavelength plate, the incident light enters the wavelength coupling device 41 in a 90-degree rotated linearly polarized state with the rotated portion of the incident light returned to its initial state. The light incident on the wavelength coupling device 41 is diffracted by the wavelength coupling device 41. Finally, +1 aberration light in a linearly polarized state enters a light receiving element (not shown) and is detected.

As described above, the optical pickup apparatus of the second embodiment can produce the same effects as the first embodiment of the present invention.

In addition, the λ/4 wavelength plate 51, which functions as a λ/4 wavelength plate for the laser light λ1 having a wavelength of 405 nm and functions as a λ/2 wavelength plate for the laser light λ2 having a wavelength of 650 nm and the laser light λ3 having a wavelength of 780 nm, is arranged on the optical axis between the object lens 21 and the wavelength coupling device 41, so only the laser light λ3 of three types of laser light λ1, λ2 and λ3 enters the wavelength coupling device 41 in a polarized state different from those of the other types of light and is diffracted, thus allowing the other types of aberration light except for 0 aberration light to be used. As a result, it is possible to guarantee the sufficient distance L between the object lens 21 and the surface of the optical disc and the WD, and also to provide a feedback light countermeasure to one laser light.

Additionally, although the λ/4 wavelength plate 51 is arranged on the optical axis between the object lens 21 and the wavelength coupling device 41 in the second embodiment of the present invention, this embodiment is not limited to the λ/4 wavelength plate 51 if the other types of aberration light except for 0 aberration light of at least one of the three types of laser light λ1, λ2 and λ3 is distorted and the polarized state thereof is changed.

As described above, in accordance with the wavelength coupling device of the present invention, the focal length of at least one beam of transmitted light can be varied by emitting at least one of the three types of light incident on the optical transmission medium at an angle different from its incident angle and emitting the others at angles equal to their incident angles, respectively. In addition, a drive mechanism and a control mechanism are not required by the wavelength coupling device of the present invention, so an apparatus combined with the device can be manufactured at low cost.

In accordance with the optical pickup apparatus of the present invention, the wavelength coupling device is arranged between the light emitting device and the object lens, so it is possible to guarantee a sufficient length WD to drive an object lens in a range where optical characteristics, such as the distance L between the object lens and the surface of optical information storage medium and aberration, are valid for three types of light having three different wavelengths. As a result, information can be written on and read from three types of optical information storage mediums corresponding to the three types of light having three different wavelengths by using a single object lens. In addition, a drive mechanism and a control mechanism are not required by the optical pickup apparatus of the present invention, so the optical pickup apparatus the can be manufactured at low cost.

As described above, it is possible to provide a wavelength coupling device and optical pickup apparatus equipped therewith, which can be fabricated to have a small size, can be manufactured at low cost, and can write information on and read information from three types of optical information storage mediums corresponding to three types of light having three different wavelengths, respectively, by using a single object lens.

What is claimed is:

1. A wavelength coupling device, comprising:
an optical transmission medium for transmitting three types of light having three different wavelengths, wherein at least one type of light of the three types of light incident on the optical transmission medium is emitted at an angle different from its incident angle and the other types of light emitted at angles equal to their incident angles, respectively.

2. The wavelength coupling device according to claim 1, wherein the one type of light is emitted at an angle that allows the one type of light to expand from the optical transmission medium along a traveling direction of the one type of light.

3. The wavelength coupling device according to claim 1, wherein the optical transmission medium is a hologram device.

4. The wavelength coupling device according to claim 2, wherein the optical transmission medium is a hologram device.

5. An optical pickup apparatus having three light emitting elements for emitting three types of light having different wavelengths, a lens system provided with an object lens for both focusing light emitted from the light emitting elements on an optical information storage medium, and focusing and transmitting refracted feedback light emitted from the optical information storage medium, and a light receiving element for detecting the transmitted, reflected feedback light, comprising:
a wavelength coupling device according to claim 1 between a light emitting device and the object lens.

6. An optical pickup apparatus having three light emitting elements for emitting three types of light having different wavelengths, a lens system provided with an object lens for both focusing light emitted from the light emitting elements on an optical information storage medium, and focusing and transmitting refracted feedback light emitted from the optical information storage medium, and a light receiving element for detecting the transmitted, reflected feedback light, comprising:
a wavelength coupling device according to claim 2 between a light emitting device and the object lens.

7. An optical pickup apparatus having three light emitting elements for emitting three types of light having different wavelengths, a lens system provided with an object lens for both focusing light emitted from the light emitting elements on an optical information storage medium, and focusing and transmitting refracted feedback light emitted from the optical information storage medium, and a light receiving element for detecting the transmitted, reflected feedback light, comprising:
a wavelength coupling device according to claim 3 between a light emitting device and the object lens.

8. An optical pickup apparatus having three light emitting elements for emitting three types of light having different wavelengths, a lens system provided with an object lens for both focusing light emitted from the light emitting elements on an optical information storage medium, and focusing and transmitting refracted feedback light emitted from the optical information storage medium, and a light receiving element for detecting the transmitted, reflected feedback light, comprising:
a wavelength coupling device according to claim 4 between a light emitting device and the object lens.

9. The optical pickup apparatus according to claim 5, wherein the reflected feedback light has a polarization direction corresponding to a polarization direction of the emitted light.

10. The optical pickup apparatus according to claim 6, wherein the reflected feedback light has a polarization direction corresponding to a polarization direction of the emitted light.

11. The optical pickup apparatus according to claim 7, wherein the reflected feedback light has a polarization direction corresponding to a polarization direction of the emitted light.

12. The optical pickup apparatus according to claim 8, wherein the reflected feedback light has a polarization direction corresponding to a polarization direction of the emitted light.

13. The optical pickup apparatus according to claim 5, further comprising a wavelength plate disposed between the wavelength coupling device and the object lens.

14. The optical pickup apparatus according to claim 6, further comprising a wavelength plate disposed between the wavelength coupling device and the object lens.

15. The optical pickup apparatus according to claim 7, further comprising a wavelength plate disposed between the wavelength coupling device and the object lens.

16. The optical pickup apparatus according to claim 8, further comprising a wavelength plate disposed between the wavelength coupling device and the object lens.

17. The optical pickup apparatus according to claim 9, further comprising a wavelength plate disposed between the wavelength coupling device and the object lens.

18. The optical pickup apparatus according to claim 10, further comprising a wavelength plate disposed between the wavelength coupling device and the object lens.

19. The optical pickup apparatus according to claim 11, further comprising a wavelength plate disposed between the wavelength coupling device and the object lens.

20. The optical pickup apparatus according to claim 12, further comprising a wavelength plate disposed between the wavelength coupling device and the object lens.
